(19) United States
(12) Patent Application Publication
(10) Pub. No.: US 2013/0218893 A1
(43) Pub. Date: Aug. 22, 2013

(54) EXECUTING IN-DATABASE DATA MINING PROCESSES

(71) Applicants: GIRISH KALASA GANESH PAI, Bangalore (IN); Arindam Bhattacharjee, Bangalore (IN)

(72) Inventors: GIRISH KALASA GANESH PAI, Bangalore (IN); Arindam Bhattacharjee, Bangalore (IN)

(21) Appl. No.: 13/398,844

(22) Filed: Feb. 17, 2012

(51) Int. Cl. G06F 17/30

(52) U.S. Cl. 707/737; 707/776; 707/E17.014

(57) ABSTRACT

Various embodiments of systems and methods for executing in-database data mining processes are described herein. In one aspect, the method includes identifying a newly created chain comprising a plurality of components connected together to perform a data mining task, generating an identifier (ID) for the newly created chain, identifying metadata associated with the chain, and storing the ID and the metadata related to the newly created chain into a repository. Each component comprises a parameterized script including one or more parameters. Values of the parameters are stored in the repository. The parameters within the scripts are replaced by their corresponding values and the components of the chain are executed sequentially to generate a final output.

### BACKGROUND

Data mining processes enable users to statistically analyze data related to their business. Data mining processes (e.g., filtering data, classifying data, clustering data) help in understanding data. For example, in generating predictive models that may be analyzed by the users to predict future of their business. Usually, data is fetched from a database onto an application server to perform data mining processes. Logics are executed on the application server to perform data mining. However, fetching data from the database and then filtering data on the application server to obtain relevant data for analysis may be a time consuming process. Further, frequent communication of data between the database and the application server requires larger bandwidth which reduces processing speed and efficiency.

In-database data mining may address the above problems. In in-database data mining, logics (e.g., filtering) are executed inside the database to fetch relevant data onto the application server for analysis. Therefore, in-database data mining is relatively efficient since logics are executed inside the database. The logics for performing data mining task are hardcoded by the users using scripting languages. Hardcoded scripts, e.g., SQL (Structured Query Language) scripts, are then executed by a database engine to perform data filtering or data mining. Different database vendors provide different algorithms with different scripts such as SQL scripts, R scripts, fuzzy logics, etc., for performing in-database data mining. Therefore, users are typically required to learn different scripts to hardcode logics for performing data mining.

### SUMMARY

Various embodiments of systems and methods for executing in-database data mining processes are described herein. In one aspect, the method executed by one or more computers in a network of computers includes identifying a newly created chain comprising a plurality of components connected together, generating an identifier (ID) for the newly created chain, identifying metadata related to the newly created chain, and storing the ID and the metadata related to the newly created chain into a repository. The chain may be altered or executed. Each component of the chain includes a parameterized script with one or more parameters. The components are executed by executing their respective script.

These and other benefits and features of embodiments of the invention will be apparent upon consideration of the following detailed description of preferred embodiments thereof, presented in connection with the following drawings.

### BRIEF DESCRIPTION OF THE DRAWINGS

The invention is illustrated by way of example and not by way of limitation in the figures of the accompanying drawings in which like references indicate similar elements. The embodiments, together with its advantages, may be best understood from the following detailed description taken in conjunction with the accompanying drawings.

FIG. 1 is a flow chart illustrating the steps performed to maintain a chain for performing in-database data mining, according to an embodiment.

FIG. 2 is a flow chart illustrating the steps performed while executing the chain, according to an embodiment.

FIG. 3 is a block diagram of a system including a tool engine coupled to a data mining tool for executing in-database data mining, according to an embodiment.

FIG. 4 is a block diagram of the data mining tool including various predefined components for creating a chain to perform a data mining task, according to an embodiment.

FIG. 5 is a block diagram of a property window of an exemplary component of the chain, according to an embodiment.

FIG. 6 illustrates an exemplary chain comprising multiple sub chains, according to an embodiment.

FIG. 7 is a block diagram of an exemplary computer system, according to an embodiment.

### DETAILED DESCRIPTION

Embodiments of techniques for executing in-database data mining processes are described herein. In the following description, numerous specific details are set forth to provide a thorough understanding of embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

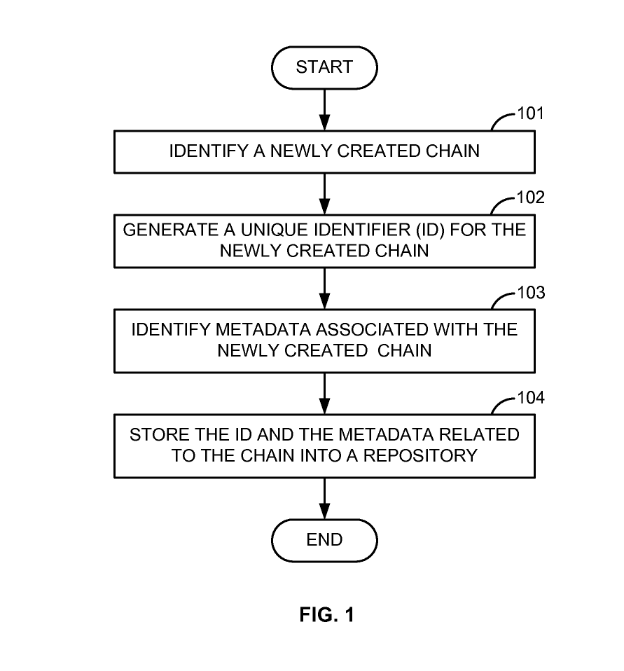

FIG. 1 is a flowchart illustrating a method for maintaining a chain generated by a user for executing in-database data mining processes, according to one embodiment. The chain comprises a plurality of components connected together in a hierarchical topology such as a tree structure. Each of the components may be one of an algorithm component, a data source component, a data writer component, a data preprocessor component, etc. The user selects the components and connects the components to create the chain as per their requirement. A new chain created by the user is identified at step 101. In one embodiment, the chain is created by selecting a plurality of predefined components from a list-of-predefined-components. The user drags and drops the required components from the list-of-predefined-components and connects the components to create the chain. In another embodiment, the chain may be created by hardcoding extensible markup language (XML) script. Once the new chain is identified, a unique identifier (ID) is created for the chain at step 102. Various information or metadata related to the chain are identified at step 103. The metadata related to chain may include information related to the plurality of components comprising the chain. The ID and the metadata related to the chain are stored in a repository at step 104.

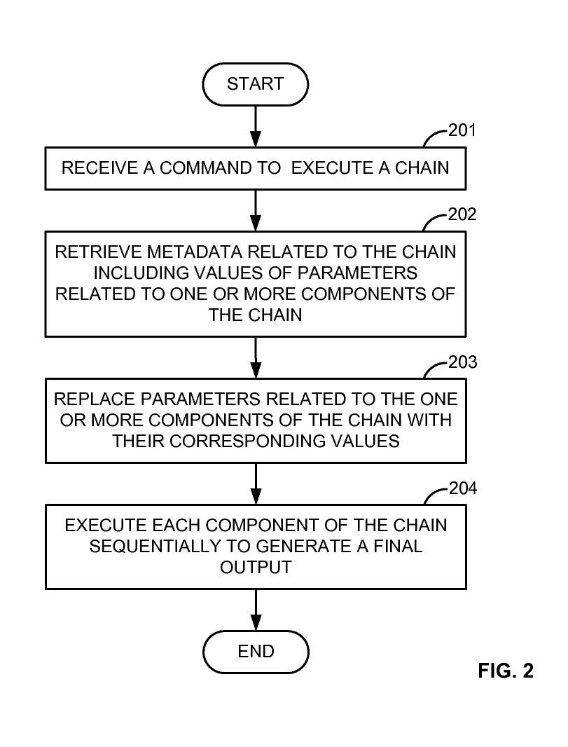

FIG. 2 is a flowchart illustrating a method for executing the chain, according to one embodiment. The user may provide a command to execute the chain. In one embodiment, the command may be provided by selecting an icon. In another embodiment, the command may be provided by hardcoding a structured query language (SQL) script, e.g., EXECUTE CHAIN<CHAIN ID>. The command is received at step 201. Once the command is received, the metadata related to the chain is retrieved at step 202. The metadata includes various information related to one or more components of the chain. Each component includes a parameterized script, e.g., a parameterized SQL script including one or more parameters. In one embodiment, the metadata includes values of parameters. The values of the parameters may be predefined or received from the user. The parameters within the SQL scripts of the components are replaced by their respective values at step 203. Once the parameters are replaced by their respective values, each component of the chain is executed sequentially to generate a final output at step 204. Each component is executed by sending their respective SQL script to a database engine for execution.

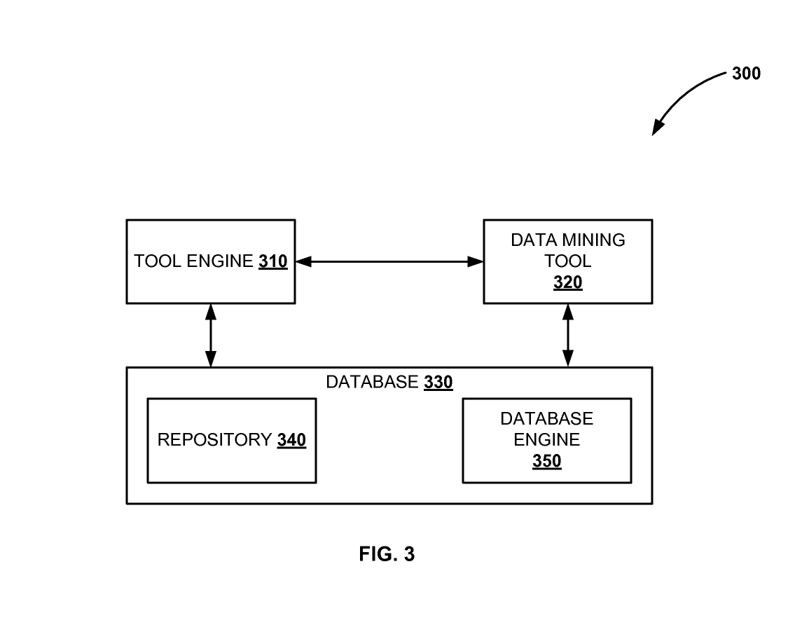

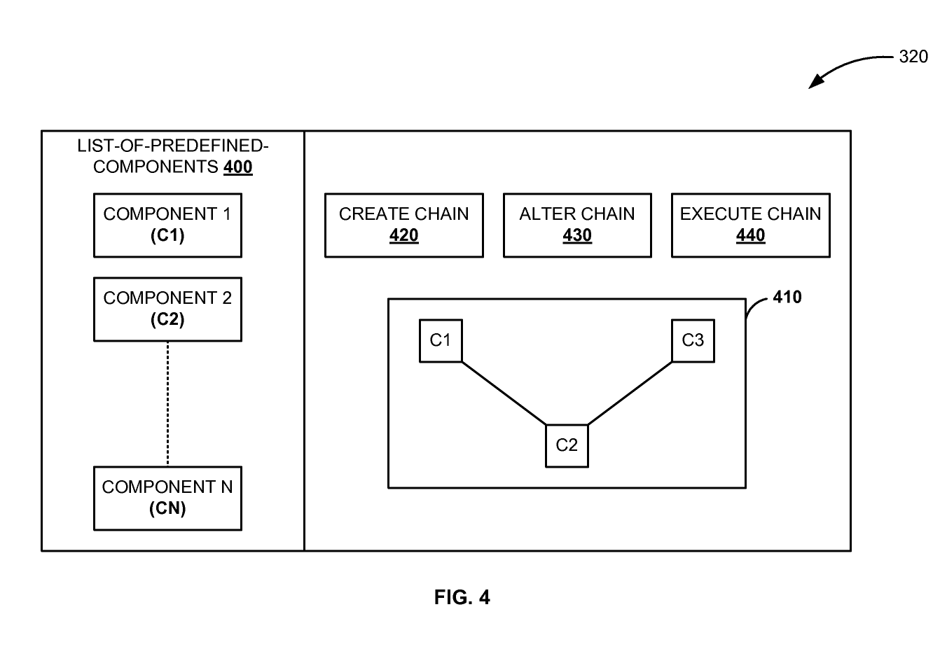

FIG. 3 illustrates one embodiment of a system 300 including a tool engine 310 communicatively coupled to a data mining tool (DMT) 320 for performing in-database data mining. The DMT 320 includes a list-of-predefined-components 400 (FIG. 4). A user selects one or more components, e.g., the components C1-C3, from the list-of-predefined-components 400. The user connects the selected components C1-C3 to create a chain 410 (FIG. 4) for performing a data mining task. Once the user creates the chain 410, the tool engine 310 identifies the chain 410 and generates a unique identifier (ID) corresponding to the chain 410. In one embodiment, the tool engine 310 returns the ID to a database 330. The database 330 stores the ID in a repository 340. In one embodiment, the repository 340 also stores various metadata related to the chain 410. The command for executing the chain 410 is received from the user. Each component C1-C3 of the chain 410 includes a parameterized script, e.g., a parameterized SQL script. The parameterized SQL script includes one or more parameters or variables. Once the command for executing the chain 410 is received, the metadata related to the chain 410 is retrieved from the metadata repository 340. In one embodiment, the metadata includes values of parameters included within the SQL script of the components C1-C3. The parameters within the SQL scripts of the components C1-C3 are replaced by their corresponding values. Each component C1-C3 of the chain 410 is executed sequentially. The components C1-C3 are executed by sending their respective SQL script to a database engine 350 for execution. Once the chain 410 is executed, a final output is generated and stored in the database 330 for further analysis. The final output may be transferred to the DMT 320 based upon the user's request.

The DMT 320 helps user in analyzing data related to their business. The user may generate predictive models using the DMT 320. The predictive models help in predicting a behavior, e.g., an increasing trend or a decreasing trend of the data. Based upon the behavior of the data, various business decisions may be taken. In one embodiment, the DMT 320 may be a Predictive Analysis Process Designer (PAPD) tool developed by SAP® AG. The DMT 320 may include the list-of-predefined-components 400. The list-of-predefined-components 400 include the plurality of predefined components C1-CN which helps in performing data mining task.

The predefined components C1-CN helps in performing data mining task. Each component C1-CN represents a logical unit that performs an expertise task. For example, the components C1-CN may each be a procedure or a set of steps to perform a specific task. In one embodiment, each component C1-CN may be one of a data source component which retrieves data from a database table, an algorithm component comprising various data mining algorithms, a data writer component which is used to export or write an output onto a data file, a data preprocessor component which performs preprocessing operations such as sorting, filtering, merging, etc. In one embodiment, the algorithm component is one of a clustering algorithm, a classification algorithm, and a regression algorithm, etc. In one embodiment, a new component corresponding to a new algorithm or a new process may be plugged-in or included within the DMT 320.

The components C1-CN include the parameterized SQL script. The parameterized SQL script includes the one or more variables or parameters. A value of a parameter may be either predefined or specified by the user. For example, the component C1 may be the data source component that includes the parameterized SQL script with one or more parameters. The component C1 (data source component) may include the parameterized SQL script for retrieving data from the database 330, as shown below: insert into % OUTPUT_TABLE_NAME % (select % INPUT_COLS % from % INPUT TABLE %).

The above parameterized SQL script of the component C1 includes the parameters namely INPUT_COLS and INPUT TABLE. The parameterized SQL script of the component C1 generates an output table. The output table is represented as “OUTPUT_TABLE_NAME” in the parameterized SQL script. The output table includes one or more columns “INPUT_COLS” from the database table “INPUT_TABLE.” The output table “OUTPUT_TABLE_NAME,” the database table “INPUT_TABLE,” and the columns “INPUT_COLS” are the parameters in the above parameterized SQL script of the component C1. The value of the parameters may be provided by the user.

For example, the user may provide the value of “INPUT_TABLE” as “Table 1.” The Table 1 as shown below may be a table from the database 330:

TABLE 1

| Product Name | Quantity Sold | Country | Sales Revenue (crore) |
|---|---|---|---|
| T-shirt | 2867 | X | 19.7 |
| Shirt | 1197 | Y | 13.4 |
| Sweat-shirt | 945 | Z | 8.9 |
| Trouser | 8546 | X | 11.6 |
| Shoes | 659 | X | 6.7 |
| Socks | 2745 | Y | 18.2 |
| Socks | 558 | X | 6 |
| Shirt | 1067 | X | 17.6 |
| Sweat-shirt | 1174 | Z | 14.8 |
| Shoes | 645 | Y | 6.3 |
| Sweat-shirt | 9781 | X | 13.2 |

The user may also provide the value of the parameter “INPUT_COLS” as columns of Table 1 that is to be selected. For example, the user may provide the value of “INPUT-COLS” as “product name, country, sales revenue.” Based upon the above-mentioned values of the parameters, the component C1 generates the output table “output_table_{—}1” including the columns “product name, country and revenue.”

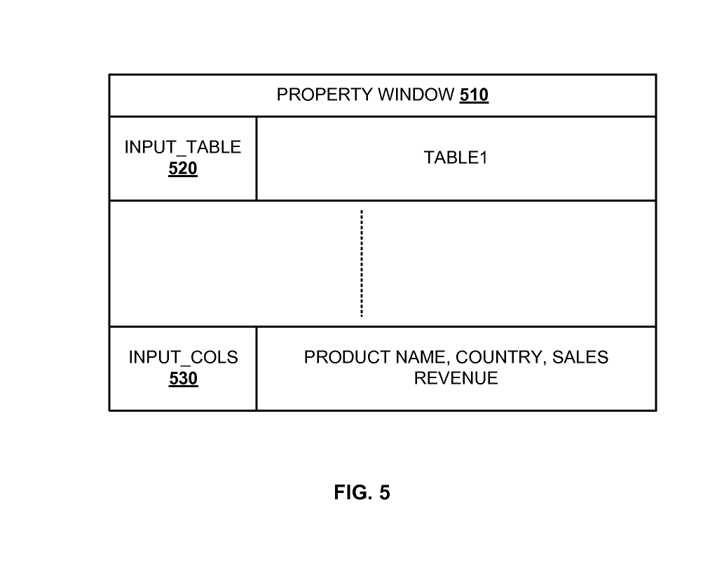

Referring to FIG. 5, in one embodiment, the values of the parameters may be provided through a property window. The user may select, e.g., double clicks, the component C1 to display a property window 510 related to the component C1. The property window 510 includes various parameters related to the component C1. For example, the property window 510 may include the parameters “INPUT_TABLE” 520 and “INPUT_COLS” 530 included within the SQL script of the component C1. The parameters “INPUT_TABLE” 520 and “INPUT_COLS” 530 may have default values, e.g., Table X and ALL columns. The default values of the parameters may be altered or edited by the user. Users can customize the component C1 as per the requirement.

Referring back to FIG. 4, the user may select one or more components C1-C3. The selected components C1-C3 may be customized. For example, the user may provide various parameters related to the parameterized SQL scripts of the components C1-C3. The user may connect the selected components C1-C3 to create the chain 410. In one embodiment, the user may drag-and-drop the components C1-C3 from the list-of-predefined-components 400 and connects the components C1-C3 to create the chain 410.

In one embodiment, the DMT 320 may suggest possible associations or connection between the components C1-C3. For example, the DMT 320 may suggest a direct link or connection between the component C1 and C3. The user may accept the connection suggested by the DMT 320 or the user may explicitly connect the components C1-C3 as per their requirement. For example, the user may connect the component C1 to C2 and the component C2 to the component C3, as illustrated in FIG. 4.

Once the chain 410 is created, the tool engine 310 generates the ID for the chain 410. The ID is transferred to the database 330. The database 330 stores the ID in the repository 340. In one embodiment, as shown in FIG. 3, the repository 340 may be included inside the database 330. In another embodiment, the repository 340 may be positioned outside the database 330. The repository 340 may be an object store or a central server.

The repository 340 also stores the metadata related to the chain 410. For example, the repository 340 may store the metadata indicating connection between different components C1-C3 of the chain 410 and the values of the parameters related to the SQL script of the components C1-C3. The repository 340 may be accessed to retrieve various metadata related to the chain 410.

The chain 410 can be altered or executed. In one embodiment, the DMT 320 may include an icon ‘create chain’ 420, ‘alter chain’ 430, and ‘execute chain’ 440 for creating, altering, and executing chain, respectively. The chain 410 may be altered by selecting the icon ‘alter chain’ 430. The user can change the connectivity between the components C1-C3. Also, the user can remove or delete any component C1-C3 of the chain 410. Further, a new component, e.g., C5 can be easily dragged and included within the chain 410.

The chain 410 may be executed by selecting the icon ‘execute icon’ 440. Once the icon ‘execute chain’ 440 is selected, the tool engine 310 retrieves the metadata related to the chain 410 including the values of the parameters related to each component C1-C3 of the chain 410. The parameter within the SQL script of each component C1-C3 may be substituted with their corresponding values. Each component C1-C3 of the chain 410 is executed sequentially, e.g., from the component C1 to the component C3.

In one embodiment, the chain 410 may be represented in the hierarchical topology such as a tree structure. A first component C1 of the chain 410 is a root component (i.e., the component having no parent component) and a last component C3 of the chain 410 is a leaf component (i.e., component having no child component), with component C2 being a child component of the component C1. In one embodiment, the chain 410 may be executed sequentially from root component C1 to leaf component C3.

Each component C1-C3 of the chain 410 is executed by firing their respective SQL script onto the database engine 350. The database engine 350 executes the SQL script. Once the last component C3 (leaf component) of the chain 410 is executed, the final output is generated. In one embodiment, the final output is stored in the database 330. In another embodiment, based upon the user's request, the final output may be displayed on a user interface.

An execution of the exemplary chain 410 may be described in the following paragraphs. In one embodiment, the root component C1 of the chain 410 is executed first. At the time of execution of the component C1, the tool engine 310 retrieves the information related to the component C1. For example, the tool engine 310 may retrieve the values of the parameters INPUT_TABLE 520 and INPUT_COLS 530 included within the parameterized SQL script of the component C1 from the repository 340. The tool engine 310 may retrieve the values “Table 1” and “product name, country, sales revenue” from the repository 340. The parameters INPUT_TABLE and INPUT_COLS included within the parameterized SQL script of the component C1 is replaced by their corresponding values “Table 1” and “product name, country, sales revenue.” The completed SQL script of the component C1 with substituted parameters is generated, as shown below: insert into output_table_{—}1 (select product name, country, sales revenue from Table 1).

The component C1 fires the completed SQL script onto the database engine 350. The database engine 350 executes the completed SQL script and generates the output_table_{—}1 shown below as Table 2:

TABLE 2

| Product Name | Country | Sales Revenue (crore) |
|---|---|---|
| T-shirt | X | 19.7 |
| Shirt | Y | 13.4 |
| Sweat-shirt | Z | 8.9 |
| Trouser | X | 11.6 |
| Shoes | X | 6.7 |
| Socks | Y | 18.2 |
| Socks | X | 6 |
| Shirt | X | 17.6 |
| Sweat-shirt | Z | 14.8 |
| Shoes | Y | 6.3 |
| Sweat-shirt | X | 13.2 |

In one embodiment, based upon the user's request, the output_table_{—}1 may be displayed on the user interface. In another embodiment, the tool engine 310 passes the output_table_{—}1 generated by the component C1 to the next component in the hierarchy, i.e., the component C2 of the chain 410.

The component C2 may be a filtering logic which is meant for filtering the information of the output_table_{—}1 generated by the component C1. The component C2 filters the output_table_{—}1 based upon some parameters. For example, the component C2 filters data of the ouput_table_{—}1 based upon the value of the column “country” as “country=X.” The parameterized SQL script of the component C2 may be as shown below:

insert into % OUTPUT_TABLE_NAME % (SELECT % INPUT_COLS % from % INPUT_TABLE_NAME % where % COLUMN_NAME %=% VALUE %).

The above parameterized SQL script of the component C2 generates the output “OUTPUT_TABLE_NAME.” The “OUTPUT_TABLE_NAME” includes one or more columns “INPUT_COLS” having “COLUMN_NAME=VALUE” from the “INPUT_TABLE_NAME.” The value of the parameters “INPUT_COLS” and “COLUMN_NAME=VALUE” may be provided by the user. For example, the user may provide the value of “INPUT_COLS” as {product name, country, sales revenue} and the value of the “COLUMN_NAME=VALUE” as {country=X}. In one embodiment, the tool engine 310 internally assigns a name of the “OUTPUT_TABLE_NAME” as output_{—}2. The tool engine 310 automatically replaces the parameter “INPUT_TABLE_NAME” with the output of the component C1, i.e., output_table_{—}1.

The tool engine 310 replaces the parameters “OUTPUT_TABLE_NAME,” “INPUT_COLS,” “INPUT_TABLE_NAME,” and “COLUMN_NAME=VALUE” in the parameterized SQL script of the component C2 with output_{—}2, {product name, country, sales revenue}, output_table_{—}1, and {country=X}, respectively. The completed SQL script with replaced parameters is generated, as shown below:

insert into output_{—}2 (SELECT product name, country, sales revenue from output_table_{—}1 where country=“X”).

The component C2 fires the completed SQL script onto the database engine 350. The database engine 350 executes the completed SQL script and generates the output (output_{—}2). In one embodiment, the output_{—}2 may be the Table 3 as shown below:

TABLE 3

| Product Name | Country | Sales Revenue (crore) |
|---|---|---|
| T-shirt | X | 19.7 |
| Trouser | X | 11.6 |
| Shoes | X | 6.7 |
| Socks | X | 6 |
| Shirt | X | 17.6 |
| Sweat-shirt | X | 13.2 |

In another embodiment, the output_{—}2 may be a pointer pointing to one or more fields of the output_table_{—}1. A field may comprise a row or a column. In one embodiment, the field may be an intersection of the one or more rows and the one or more columns. For example, the output_{—}2 may points to rows 1, 4-5, 7-8, and 11 of the output_table_{—}1. In one embodiment, if the user request to display the output_{—}2, the tool engine 310 generates the table (Table 3 shown above) corresponding to the pointer information and displays to the user.

In one embodiment, the tool engine 310 passes the output 2, generated by the component C2, as the input to the next component C3 of the chain 410. The component C3 may be the clustering algorithm to group input data into different groups or clusters. The parameterized SQL script of the component C3 may be as shown below:

CREATE PROCEDURE CLUSTERING( IN dataset, IN nClusters , OUT
outTableName)
BEGIN
{
pal::kmeans(dataset, nClusters, outTableName);
}
END
CALL CLUSTERING (%INPUT_TABLE_NAME%,
%NUMBER_OF_CLUSTERS%, %OUTPUT_TABLE%).

In the above SQL script, ‘IN’ indicates ‘input,’ ‘OUT’ indicates ‘output,’ and dataset indicates the input table upon which clustering is to be performed. For example, the output table of the component C2 (output_{—}2) may be the dataset or input table for the component C3. ‘nClusters’ indicates a number of clusters or groups the dataset is to be divided into and the ‘outTableName’ is the final output generated by the component C3 as the result of clustering. The function “pal::kmeans(dataset, nClusters, outTableName)” is an exemplary function used to perform clustering using a kmeans algorithm. The function clusters the ‘dataset’ into ‘nClusters’ to generate the output table ‘outTableName.’ The function may vary depending upon the type of the database implemented. The value of the parameter “NUMBER_OF_CLUSTERS” may be provided by the user. For example, the user may provide the “NUMBER_OF_CLUSTERS” as “3.”

The tool engine 310 substitutes the parameters “INPUT_TABLE_NAME,” “NUMBER_OF_CLUSTERS,” and “OUTPUT_TABLE” in the parameterized SQL script of the component C3 by the values “output_{—}2,” “3,” and “output_{—}3,” respectively. The completed SQL script of the component C3 with substituted parameters is generated. The completed SQL script of the component C3 may be as shown below:

CREATE PROCEDURE CLUSTERING( IN dataset, IN nClusters , OUT
outTableName)
BEGIN
{
pal::kmeans(dataset, nCLusters, outTableName);
}
END
CALL CLUSTERING (output_2, 3, output_3).

The component C3 fires the completed SQL script onto the database engine 350. The database engine 350 executes the completed SQL script and generates the final output, i.e., output_{—}3 may be shown as Table 4 below:

TABLE 4

| Product Name | Country | Sales Revenue (crore) | Cluster Number |
|---|---|---|---|
| T-shirt | X | 19.7 | 1 |
| Trouser | X | 11.6 | 2 |
| Shoes | X | 6.7 | 3 |
| Socks | X | 6 | 3 |
| Shirt | X | 17.6 | 1 |
| Sweat-shirt | X | 13.2 | 2 |

The final output may be stored in the database 330. In one embodiment, the final output may be transmitted to the user interface or DMT 320 for further analysis.

In one embodiment, the processing starts from the leaf component C3. The leaf component C3 queries its parent component C2 for the required input (i.e., output_{—}2). The parent component C2 in turn queries its parent component C1 for the required input (i.e., output_table_{—}1). As the parent component C1 is the root component which is not dependent upon the output of any other component. Therefore, the root component C1 is executed to generate the output (e.g., output_table_{—}1). The output_table_{—}1 generated by the root component C1 is passed to its child component C2. Upon receiving the output_table_{—}1, the component C2 is executed to generate the output_{—}2. The output_{—}2 generated by the component C2 is passed as the input to its child component C3. In one embodiment, the tool engine 310 passes the output generated by the component C1 (output_table_{—}1) and the output generated by the component C2 (output_{—}2) as the inputs to the component C3. As the component C3 is the leaf component, the component C3 is executed to generate the final output, e.g., output_{—}3. The final output may be stored in the database 330. In one embodiment, the final output may be displayed on the user interface or the DMT 320.

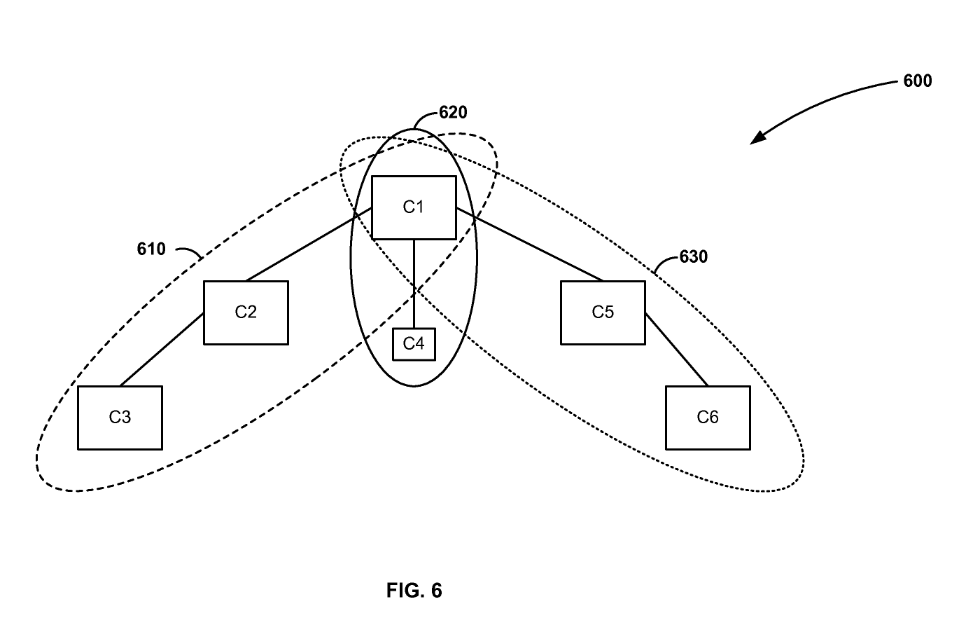

In another embodiment, the chain may be a complex chain 600, as illustrated in FIG. 6. The complex chain 600 may include a plurality of sub chains 610, 620, and 630. Each sub chain 610, 620, and 630 may be executed by any of the methods discussed above. Typically, the tool engine 310 identifies all the leaf components C3, C4, and C6 of the complex chain 600. The leaf components C3, C4, and C6 may be placed in a FIFO (first-in-first-out) list such as a queue. The tool engine 310 may start with the first entered leaf component, e.g., C3, and executes the first sub chain 610. The sub chain 610 may be executed by any of the method, discussed above. Once the sub chain 610 corresponding to the first leaf component C3 is executed, the tool engine 310 identifies a next entered leaf component C4 in the FIFO list. The sub chain 620 corresponding to the next leaf component C4 is then executed. Similarly, the sub chain 630 is finally executed. In one embodiment, the leaf components C3, C4, and C6 may be placed in a LIFO (last-in-first-out) list such as a stack. When the leaf components C3, C4, and C6 are placed in the LIFO list, the sub chain 630 corresponding to the last entered component C6 is executed first, then the sub chain 620 is executed, and finally the sub chain 610 corresponding to the first entered component C1 is executed. In another embodiment, the sub chains 610-630 may be executed in sequence specified by the user.

In one embodiment, if the tool engine 310 is embedded inside the database 330, the users not having the predefined components C1-CN (e.g., the non PAPD users) may still create or execute the chain using SQL constructs. Typically, the user can create and/or execute the chain by hardcoing SQL scripts. The user can write SQL scripts for creating chain, altering chain, and executing chain similar to writing SQL scripts for creating table, altering table, and executing table. The capability of the database engine 350 increases and the database engine 350 starts recognizing create chain, alter chain, and execute chain.

For example, the user may write the following SQL script for creating chain comprising the component C1 and the component C2:

CREATE CHAIN<createchain><component 1 tableName= “table 1”
selectedCols = “Product Name, Country,Revenue” ><component 2
parent=component1 Cols = “Country” Value= “X”></createChain>
<ChainDescription>
<ComponentDescription name=″C1″>
<property >
<attribute> name = ″INPUT_TABLE″ value =″table1″ </attribute>
<attribute> name = ″INPUT_COLS″ value=″Product Name,
Country,Revenue″</attribute>
</property>
<parent >
</parent>
</ComponentDescription>
<ComponentDescription name=″C2″>
<property >
<attribute> name = ″COLUMN_NAME″ value =″Country″ </attribute>
<attribute> name = ″VALUE” value=″X″</attribute>
</property>
<parent name=″C1″>
</parent>
</ComponentDescription>
</ChainDescription>

Once the user writes the SQL script for creating chain, the tool engine 310 generates the ID corresponding to the chain. The ID and the various parameters related to the chain are stored in the repository 340. The user may execute the chain by writing the following SQL script:

### EXECUTE CHAIN<CHAINID=“VALUE OF CHAINID”>;

If the VALUE OF CHAINID is “1,” the user may execute the chain by writing EXECUTE CHAIN<CHAINID=“1”>

The database engine 350 parse the line ‘EXECUTE CHAIN,’ and coordinate with the tool engine 310 to execute the chain with ID=1 using any of the methods described above.

Embodiments described above enable a user to easily create the chain for performing data mining tasks. The user can select the predefined components and connects the components to create the chain as per their requirement. The chain can be easily executed, e.g., on a single click, to perform the data mining task. Each component includes the predefined parameterized script for performing a specific data mining task. Consequently, it is not required to explicitly hardcode the process for performing the data mining task. Also, it is not required to be well versed with various scripting languages. The user acquainted with the data mining task can easily use the tool to perform data mining, without need to know the complex scripting languages. Therefore, the system is user friendly and saves resource, time, and effort that might be wasted in learning various scripting languages. Also, the system is very flexible and the users can easily mix-and-match the components to alter the chain when required. Additionally, the output or pointer generated while executing the intermediate components of the chain are not required to be stored. The output (e.g., pointer) can be easily and quickly accessed that increases speed and makes system more efficient. The generation of views also avoids duplication of data or generation of various intermediate tables. Again, as the output views are generated upon the original database table, there is no movement of data. The data may not leave the database until the final output is generated. Therefore, the system avoids unnecessarily duplication and communication of data that reduces bandwidth and increases efficiency. Moreover, the output generated by each component of the chain may be viewed or analyzed separately, when required.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

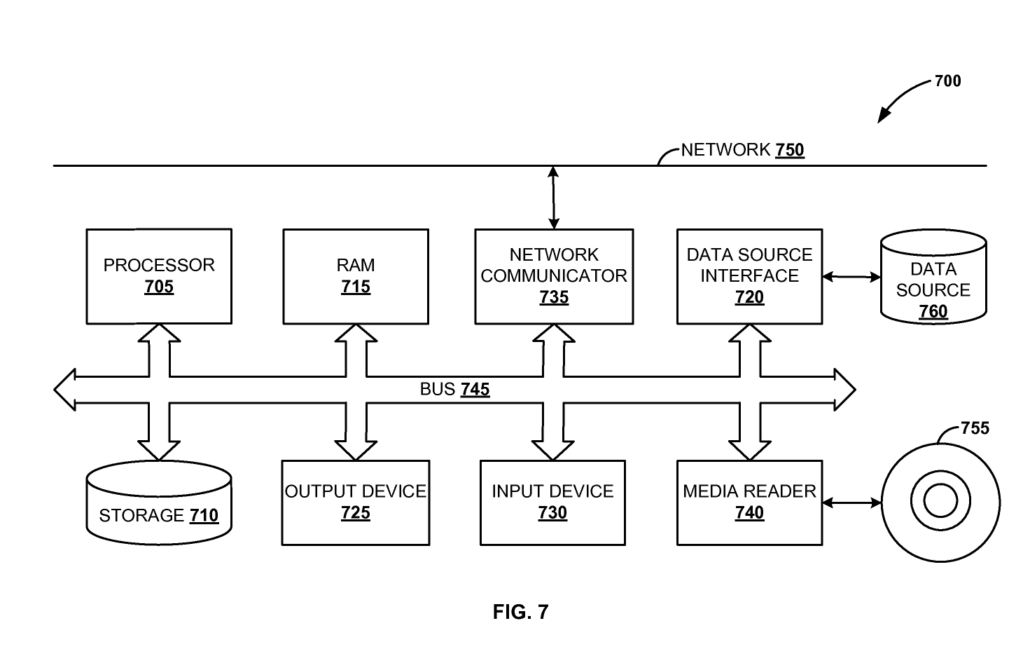

FIG. 7 is a block diagram of an exemplary computer system 700. The computer system 700 includes a processor 705 that executes software instructions or code stored on a computer readable storage medium 755 to perform the above-illustrated methods. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a non-transient computer readable storage medium to tangibly store instructions, which when executed by one or more computers in a network of computers causes performance of operations comprising:
identifying a newly created chain including a plurality of components connected together to perform a data mining task, wherein each component comprises a parameterized script with one or more parameters;
generating an identifier for the newly created chain;
identifying a metadata associated with the newly created chain; and
storing the identifier and the metadata related to the chain into a metadata repository, wherein the metadata comprises values of the one or more parameters included within the parameterized script of one or more components.

2. The article of manufacture of claim 1, wherein the parameterized script comprises a parameterized structured query language (SQL) script.

3. The article of manufacture of claim 1, wherein a component comprises one of a data source component, an algorithm component, a data writer component, and a data preprocessor component.

4. The article of manufacture of claim 3, wherein the algorithm component comprises one of a clustering algorithm, a classification algorithm, and a regression algorithm.

5. The article of manufacture of claim 1 further comprising instructions which when executed cause the one or more computers to perform the operations comprising:
receiving a command for executing the chain;
retrieving the metadata of the chain including values of the parameters related to the script of one or more components from the metadata repository;
replacing the parameters with their corresponding values; and
executing the components of the chain sequentially to generate a final output.

6. The article of manufacture of claim 5 further comprising instructions which when executed cause the one or more computers to perform the operations comprising at least one of:
storing the final output in a database; and
based upon a user's request, displaying the final output on a user interface.

7. The article of manufacture of claim 5, wherein the components are executed by sending their respective scripts to a database engine.

8. The article of manufacture of claim 5, wherein the chain comprises a tree structure including a root component and a plurality of child components and the execution of the root component comprises generation of an output including a table.

9. The article of manufacture of claim 8, wherein the execution of a child component comprises generation of an output including one of:
a table; and
a pointer referring to one or more fields of the table generated by the root component.

10. The article of manufacture of claim 8 further comprising instructions which when executed cause the one or more computers to perform the operations comprising:
identifying an output generated by a component; and
passing the output to the child component of the component.

11. A method for executing in-database data mining processes implemented on a network of one or more computers, the method comprising:
identifying a newly created chain including a plurality of components connected together to perform a data mining task, wherein each component comprises a parameterized script with one or more parameters;
generating an identifier for the newly created chain;
identifying a metadata associated with the newly created chain; and
storing the identifier and the metadata related to the chain into a metadata repository, wherein the metadata comprises values of the one or more parameters included within the parameterized script of one or more components.

12. The method of claim 11 further comprising:
receiving a command for executing the chain;
retrieving the metadata of the chain including values of the parameters related to the script of one or more components from the metadata repository;
replacing the parameters with their corresponding values; and
executing the components of the chain sequentially to generate a final output.

13. The method of claim 12 further comprising at least one of:
storing the final output in a database; and
based upon a user's request, displaying the final output on a user interface.

14. The method of claim 12, wherein the chain comprises a tree structure including a root component and a plurality of child components and wherein:
the execution of the root component comprises generation of an output including a database table; and
the execution of a child component comprises generation of an output including one of a table and a pointer referring to one or more fields of the database table generated by the root component.

15. The method of claim 14 further comprising:
identifying an output generated by a component; and
passing the output to the child component of the component.

16. A computer system for executing in-database data mining processes comprising: a memory to store program code; and
a processor communicatively coupled to the memory, the processor configured to execute the program code to cause one or more computers in a network of computers to:
identify a newly created chain including a plurality of components connected together to perform a data mining task, wherein each component comprises a parameterized script with one or more parameters;
generate an identifier for the newly created chain;
identify a metadata associated with the newly created chain; and
store the identifier and the metadata related to the chain into a metadata repository, wherein the metadata comprises values of the one or more parameters included within the parameterized script of one or more components.

17. The computer system of claim 16, wherein the processor is further configured to perform the operations comprising:
receiving a command for executing the chain;
retrieving the metadata of the chain including values of the parameters related to the script of one or more components from the metadata repository;
replacing the parameters with their corresponding values; and
executing the components of the chain sequentially to generate a final output.

18. The computer system of claim 17, wherein the processor is further configured to perform the operations comprising at least one of:
storing the final output in a database; and
based upon a user's request, displaying the final output on a user interface.

19. The computer system of claim 17, wherein the chain comprises a tree structure including a root component and a plurality of child components and wherein:
the execution of the root component comprises generation of an output including a database table; and
the execution of a child component comprises generation of an output including one of a table and a pointer referring to one or more fields of the database table generated by the root component.

20. The computer system of claim 19, wherein the processor is further configured to perform the operations comprising:
identifying an output generated by a component; and
passing the output to the child component of the component.
